(19) United States
(12) Patent Application Publication
(10) Pub. No.: US 2026/0298209 A1
(43) Pub. Date: Oct. 1, 2026

(54) SYSTEMS AND METHODS FOR RAPID DETECTION OF LIGHTNING-IMPACTED WIND TURBINES

(71) Applicant: Vestas Wind Systems A/S, Aarhus N. (DK)

(72) Inventors: Chanaka Keerthisinghe, White Plains, NY (US); Aijun Deng, State College, PA (US); Rosebud Jasmine Lambert, Canelas (PT); Fernando Miguel Laranjeira de Freitas, Porto (PT)

(73) Assignee: Vestas Wind Systems A/S, Aarhus N. (DK)

(21) Appl. No.: 19/091,794

(22) Filed: Mar. 26, 2025

(51) Int. Cl. F03D 80/30; F03D 17/00

(52) U.S. Cl. CPC F03D 80/30; F03D 17/0065; F03D 17/014; F05B 2260/80

(57) ABSTRACT

An example method includes receiving an indication of a location of a lightning strike, determining that the location of the lightning strike is within a first range of at least one wind turbine, receiving wind turbine monitoring data from the at least one wind turbine, assessing the wind turbine monitoring data from the at least one wind turbine for non-standard performance, determining if the wind turbine monitoring data indicating non-standard performance is correlated with a lightning impact, and generating an alert that the at least one wind turbine may be damaged by lightning based on the lightning strike being within a first range of the at least one wind turbine and the determination that the wind turbine monitoring data indicates non-standard performance is correlated with the lightning impact.

### TECHNICAL FIELD

Embodiments of the present invention(s) are generally related to predicting failures of variable power generation assets such as wind turbines and solar power farms, and in particular to detecting lightning impacted turbines.

### BACKGROUND

Lightning strikes to wind turbine blades can damage the blade structure, causing a blade to fail or break and resulting in a safety hazard and costly replacement. According to some estimates, approximately 77,494 wind turbines in the USA were struck by lightning in 2023. This is roughly one lightning strike per wind turbine, but in many estimates, 31% of the wind turbines had more than one lightning strike, while some had none. Fortunately, wind turbines are equipped with lightning protection systems that safely channel electrical energy into the ground. Industry experts estimate that wind turbines survive 97-99% of lightning strikes without taking any significant damage. However, 1-3% of the damaged wind turbines cost the industry $100 million annually. Damage to wind turbines often consists of blade failures, gearbox failures, or generator failures.

The rapid detection of lightning-impacted wind turbine blades is a significant task faced by the wind turbine industry. Currently, the time of discovery of the damage could be from a few hours to several months, or even years, if the damage develops slowly and the wind turbine continues to operate. In one example, for twenty-six lightning-impacted wind turbines, the median time-to-detection of lightning-related damage was 123 days, with a maximum of 391 days, based on cases with high confidence in the inspection date accuracy.

Wind turbine operators can receive lightning warnings when there are nearby lightning strikes. For example, the Vaisala network can detect lightning accurately within 100 meters in the USA and 1 kilometer globally. However, since only a small number of these strikes hit the turbine, it is a bad financial decision to shut down a wind turbine for every lightning warning. Moreover, unnecessary visits to the wind turbine increase the cost associated with wind power generation.

One technique for detecting lightning-impacted wind turbines involves installing advanced lightning current detection sensors. However, these sensors can be costly, and as a result, the majority of existing wind turbines do not have them installed.

### SUMMARY

An example non-transitory computer-readable medium comprises executable instructions. The executable instructions may be executable by one or more processors to perform an example method. In some embodiments, the example method comprises receiving an indication of a location of a lightning strike, determining that the location of the lightning strike is within a first range of the wind turbine, receiving wind turbine monitoring data from the at least one wind turbine, assessing the wind turbine monitoring data from the at least one wind turbine for non-standard performance, determining if the wind turbine monitoring data indicating non-standard performance is correlated with a lightning impact, and generating an alert that the at least one wind turbine may be damaged by lightning based on the lightning strike being within a first range of the at least one wind turbine and the determination that the wind turbine monitoring data indicates non-standard performance is correlated with the lightning impact.

The wind turbine monitoring data may be supervisory control and data acquisition (SCADA) data. In some embodiments, the wind turbine monitoring data includes SCADA and non-SCADA data and in other embodiments, the wind turbine monitoring data does not include SCADA data. In some embodiments, the wind turbine data includes sensor data and operational alarms. The sensor data may be SCADA data, non-SCADA data (e.g., sensor data), or a combination of both. Operational alarms may be generated by an operating system. In one example of SCADA data that may be included in the wind turbine monitoring data, the SCADA data may include wind speed and pitch angle, and the predicted component performance is an estimated rotor speed. Applying the features from the SCADA data to the model may comprise, for example, applying wind speed, pitch angle, and lagged rotor speed to the model. The lagged rotor speed may be a feature that is generated based on the SCADA data.

In some embodiments, determining if the wind turbine monitoring data indicating non-standard performance is correlated with the lightning impact comprises: training a model to predict performance of a component of the at least one wind turbine during healthy conditions, receiving SCADA data from the at least one wind turbine after the lightning strike occurred, applying features from the SCADA data to the model to generate a predicted component performance, and calculating a residual between predicted component performance and reported component performance after the lightning strike occurred.

The model may be one of a plurality of models. In some embodiments, there is a different model for each wind turbine or different type of wind turbine. For example, each model of the plurality of models may be for a different wind turbine. The model may include or be an XGBoost based machine learning model. It will be appreciated that the model may be or include other types of models or approaches (e.g., decision trees, random forests, GMM, and/or the like).

In some embodiments, determination that the wind turbine monitoring data indicates non-standard performance is correlated with the lightning impact comprises comparing the residual to an anomaly threshold and generating the alert. In various embodiments, the alert indicates the residual is outside the anomaly threshold and an operational alarm from the wind turbine is received after the lightning strike is detected.

The example may further comprise receiving an indication of an amplitude of the lightning strike. In some embodiments, the indication of the location of the lightning strike is received from a third-party lightning detection service.

In some embodiments, a user such as an operator responsible for supervising the at least one wind turbine that receives the alert, may change the first range to a greater or lesser range based on sensitivity to risk.

In some embodiments, assessing the wind turbine monitoring data from the at least one wind turbine for non-standard performance occurs only if the lightning strike occurs within the first range. In other embodiments, assessing the wind turbine monitoring data from the at least one wind turbine for non-standard performance occurs if there is lightning strike in an area (e.g., not within a first range) or, alternately, for other factors unrelated to recent lightning strikes.

In some embodiments, determining if the wind turbine monitoring data indicating non-standard performance is correlated with the lightning impact comprises determining, at least in part, that the wind turbine monitoring data indicated performance different than the non-standard performance immediately before the lightning strike.

An example system, comprises at least one processor and a non-transitory computer readable memory medium. The executable instructions may be executable by the at least one processor to perform the method.

The wind turbine monitoring data may be supervisory control and data acquisition (SCADA) data. In some embodiments, the wind turbine monitoring data includes SCADA and non-SCADA data and in other embodiments, the wind turbine monitoring data does not include SCADA data. In some embodiments, the wind turbine data includes sensor data and operational alarms. The sensor data may be SCADA data, non-SCADA data (e.g., sensor data), or a combination of both. Operational alarms may be generated by an operating system. In one example of SCADA data that may be included in the wind turbine monitoring data, the SCADA data may include wind speed and pitch angle, and the predicted component performance is a predicted rotor speed. Applying the features from the SCADA data to the model may comprise, for example, applying wind speed, pitch angle, and lagged rotor speed to the model. The lagged rotor speed may be a feature that is generated based on the SCADA data.

In some embodiments, determining if the wind turbine monitoring data indicating non-standard performance is correlated with the lightning impact comprises: training a model to predict performance of a component of the at least one wind turbine during healthy conditions, receiving SCADA data from the at least one wind turbine after the lightning strike occurred, applying features from the SCADA data to the model to generate a predicted component performance, and calculating a residual between predicted component performance and reported component performance after the lightning strike occurred.

The model may be one of a plurality of models. In some embodiments, there is a different model for each wind turbine or different type of wind turbine. For example, each model of the plurality of models may be for a different wind turbine. The model may include or be an XGBoost based learning model. It will be appreciated that the model may be or include other types of models or approaches (e.g., decision trees, random forests, GMM, and/or the like).

In some embodiments, determination that the wind turbine monitoring data indicates non-standard performance is correlated with the lightning impact comprises comparing the residual to an anomaly threshold and generating the alert. In various embodiments, the alert indicates the residual is outside the anomaly threshold and an operational alarmfrom the at least one wind turbine is received after the lightning strike is detected.

The example may further comprise receiving an indication of an amplitude of the lightning strike. In some embodiments, the indication of the location of the lightning strike is received from a third-party lightning detection service.

In some embodiments, a user such as an operator responsible for supervising the at least one wind turbine that receives the alert, may change the first range to a greater or lesser range based on sensitivity to risk.

In some embodiments, assessing the wind turbine monitoring data from the at least one wind turbine for non-standard performance occurs only if the lightning strike occurs within the first range. In other embodiments, assessing the wind turbine monitoring data from the at least one wind turbine for non-standard performance occurs if there is lightning strike in an area (e.g., not within a first range) or, alternately, for other factors unrelated to recent lightning strikes.

In some embodiments, determining if the wind turbine monitoring data indicating non-standard performance is correlated with the lightning impact comprises determining, at least in part, that the wind turbine monitoring data indicated performance different than the non-standard performance immediately before the lightning strike.

An example method includes receiving an indication of a location of a lightning strike, determining that the location of the lightning strike is within a first range of at least one wind turbine, receiving wind turbine monitoring data from the at least one wind turbine, assessing the wind turbine monitoring data from the at least one wind turbine for non-standard performance, determining if the wind turbine monitoring data indicating non-standard performance is correlated with a lightning impact, and generating an alert that the at least one wind turbine may be damaged by lightning based on the lightning strike being within a first range of the at least one wind turbine and the determination that the wind turbine monitoring data indicates non-standard performance is correlated with the lightning impact.

The wind turbine monitoring data may be supervisory control and data acquisition (SCADA) data. In some embodiments, the wind turbine monitoring data includes SCADA and non-SCADA data and in other embodiments, the wind turbine monitoring data does not include SCADA data. In some embodiments, the wind turbine data includes sensor data and operational alarms. The sensor data may be SCADA data, non-SCADA data (e.g., sensor data), or a combination of both. Operational alarms may be generated by an operating system. In one example of SCADA data that may be included in the wind turbine monitoring data, the SCADA data may include wind speed and pitch angle, and the predicted component performance is a predicted rotor speed. Applying the features from the SCADA data to the model may comprise, for example, applying wind speed, pitch angle, and lagged rotor speed to the model. The lagged rotor speed may be a feature that is generated based on the SCADA data.

In some embodiments, determining if the wind turbine monitoring data indicating non-standard performance is correlated with the lightning impact comprises: training a model to predict performance of a component of the at least one wind turbine during healthy conditions, receiving SCADA data from the at least one wind turbine after the lightning strike occurred, applying features from the SCADA data to the model to generate a predicted component performance, and calculating a residual between predicted component performance and reported component performance after the lightning strike occurred.

The model may be one of a plurality of models. In some embodiments, there is a different model for each wind turbine or different type of wind turbine. For example, each model of the plurality of models may be for a different wind turbine. The model may include or be an XGBoost based learning model. It will be appreciated that the model may be or include other types of models or approaches (e.g., decision trees, random forests, GMM, and/or the like).

In some embodiments, determination that the wind turbine monitoring data indicates non-standard performance is correlated with the lightning impact comprises comparing the residual to an anomaly threshold and generating the alert. In various embodiments, the alert indicates the residual is outside the anomaly threshold and an operational alarm from the at least one wind turbine is received after the lightning strike is detected.

The example may further comprise receiving an indication of an amplitude of the lightning strike. In some embodiments, the indication of the location of the lightning strike is received from a third-party lightning detection service.

In some embodiments, a user such as an operator responsible for supervising the at least one wind turbine that receives the alert, may change the first range to a greater or lesser range based on sensitivity to risk.

In some embodiments, assessing the wind turbine monitoring data from the at least one wind turbine for non-standard performance occurs only if the lightning strike occurs within the first range. In other embodiments, assessing the wind turbine monitoring data from the at least one wind turbine for non-standard performance occurs occurs if there is lightning strike in an area (e.g., not within a first range) or, alternately, for other factors unrelated to recent lightning strikes.

In some embodiments, determining if the wind turbine monitoring data indicating non-standard performance is correlated with the lightning impact comprises determining, at least in part, that the wind turbine monitoring data indicated performance different than the non-standard performance immediately before the lightning strike.

### BRIEF DESCRIPTION OF THE DRAWINGS

FIG. 1 depicts an example environment including a lightning-impacted wind turbine detection system, lightning detection service(s), and a power operator system that communicate over a communication network in some embodiments.

FIG. 2 depicts a venn diagram of three overlapping components that may be used to assess the likelihood of lightning-related damage to a wind turbine in some embodiments.

FIG. 3 depicts an example lightning-impacted wind turbine detection system in some embodiments.

FIG. 4 is a flowchart for detecting lightning-impacted wind turbines using operational data and providing alerts in some embodiments.

FIG. 5 further depicts a flowchart for training a machine learning model and evaluating sensor data (e.g., sensor measurements) from one or more wind turbines (e.g., that are proximate to lightning strikes).

FIG. 6 depicts a graph showing the validation and testing of the model in some embodiments.

FIG. 7A-7D depicts four graphs including sensor measurements from wind turbines over the same period of time in one example.

FIG. 8 depicts a graph of rotor speed to wind speed including normal operation as compared to the wind turbine rotor speed to wind speed after a lightning strike.

FIG. 9 depicts a graph showing an example where the residual increased exactly after the lightning event at 05:56:45 (HH:MM:SS) indicating an anomaly in operational data.

FIG. 10 depicts a graph of lightning-impacted wind turbine detection system alerts over time for a wind turbine in one example (Table II).

FIG. 11 is a flowchart of a process for generating an alarm (e.g., notification) of possible lightning related damage based on the determination of non-standard performance in some embodiments.

FIG. 12 is a flowchart of a process for generating an alarm (e.g., notification) of possible lightning related damage based on the determination of non-standard performance and operational alarms in some embodiments.

FIG. 13 depicts a block diagram of an example digital device 1300 according to some embodiments.

Throughout the drawings, like reference numerals will be understood to refer to like parts, components, and structures.

### DETAILED DESCRIPTION

Various embodiments described herein address detecting lightning-impacted wind turbines using wind turbine monitoring data, which is expected to provide a cost-effective solution for wind turbines without advanced lightning sensors. In one example, some embodiments utilize an anomaly detection model to detect lightning-impacted wind turbines and assist in detecting anomalies (e.g., in the rotor speed) after a turbine is suspected of being struck by lightning.

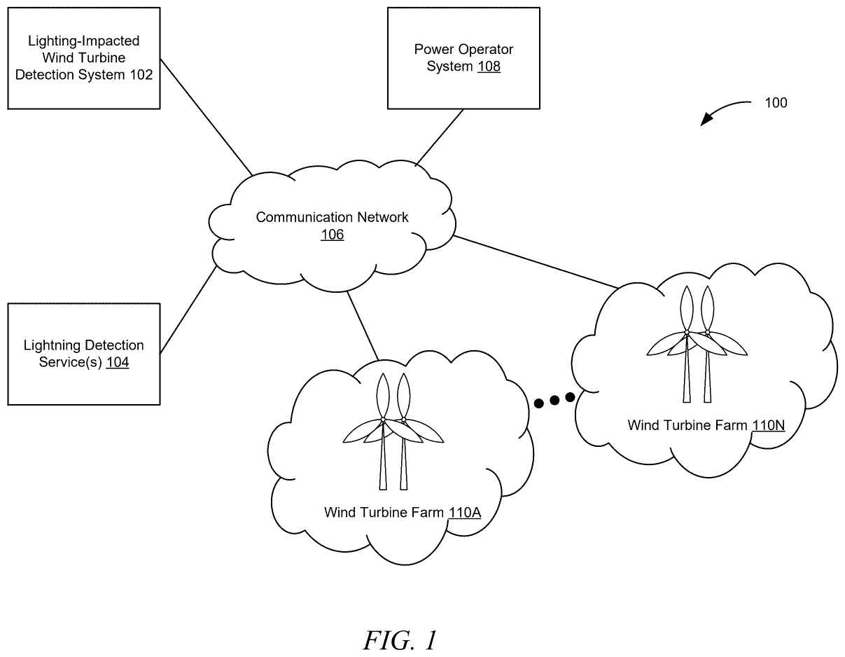

FIG. 1 depicts an example environment 100, including a lightning-impacted wind turbine detection system 102, lightning detection service(s) 104, and a power operator system 108 that communicate over a communication network 106 in some embodiments. Different wind turbine farms (e.g., wind turbine farm 110A-110N) may provide wind turbine monitoring data (e.g., sensor data such as SCADA data and/or operational alarms) to the lightning-impacted wind turbine detection system 102 and/or the power operator system 108 via the communication network 106.

Some embodiments of the lightning-impacted wind turbine detection system 102 combine lightning information (e.g., location and time of lightning strikes) with provide wind turbine monitoring data (e.g., sensor measurements and/or operational alarms) to determine if the wind turbine was likely hit by lightning and if the nearby lightning strike likely damaged the wind turbine. In one example, the lightning-impacted wind turbine detection system 102 may identify one or more lightning strikes near a wind turbine. Subsequently, the lightning-impacted wind turbine detection system 102 may determine if lightning damage-related alarms are triggered when there are nearby lightning strikes. In addition, instead of assessing lightning damage-related alarms, the lightning-impacted wind turbine detection system 102 may assess sensor data (e.g., SCADA data, non-SCADA sensor measurements, and/or generated features) from the potentially impacted wind turbine(s) to identify anomalies that may be related to lightning strikes (e.g., lightning impacts).

If lightning-related anomalies in the sensor data are identified after a lightning event (e.g., a lightning strike) is determined to have occurred proximate (e.g., within a predetermined distance) to a wind turbine, the lightning-impacted wind turbine detection system 102 may generate an alert to indicate that the wind turbine may or is likely to have suffered lightning-related damage.

Alternately, in some embodiments, if lightning-related operational alarms are generated after a lightning event is determined to have occurred proximate to the wind turbine, the lightning-impacted wind turbine detection system 102 may generate an alert to indicate that the wind turbine may or is likely to have suffered lightning-related damage.

In some embodiments, assessment or review of operational alarms are optional. In one example, if lightning-related anomalies in sensor data (e.g., features based on SCADA data) from the wind turbine are identified after a lightning event (e.g., a lightning strike within a predetermined range of the wind turbine) and, optionally, if operational alarms associated with lightning damage are generated after the same lightning event, the lightning-impacted wind turbine detection system 102 may generate an alert to indicate that the wind turbine may or is likely to have suffered lightning-related damage.

In one example, the lightning-impacted wind turbine detection system 102 may generate an alert based on the detection of lightning-related data anomalies occurring near the time a nearby lightning event occurred. The lightning-impacted wind turbine detection system 102 may or may not assess if operational alarms (e.g., operational alarms associated with lightning-related damage that are generated by an operating system) are generated near the time a nearby lightning event occurred. In this example, the alert generated by the lightning-impacted wind turbine detection system 102 may be triggered based only on the lightning-related anomalies detected (as described herein). Alternatively, the alert may be triggered based on a combination of detection of lightning-related anomalies and the generation of operational alarms from the wind turbine. In some embodiments, a user (e.g., operator) may configure when the lightning-impacted wind turbine detection system 102 generates alerts (e.g., based only on the detection of lightning-related anomalies or based on the detection of lightning-related anomalies and operational alarms from the same wind turbine as described herein).

The lightning-impacted wind turbine detection system 102 may identify anomalies in the sensor data. In some embodiments, the lightning-impacted wind turbine detection system 102 assesses wind turbine rotor speed, wind speed, and average pitch angle to determine if there are anomalies in the sensor data (e.g., that the wind turbine rotor speed, wind speed, and/or average pitch angle have non-standard performance). Sensor data may be generated by any number of sensors within or associated with a wind turbine.

In some embodiments, the sensor data may include Supervisory Control and Data Acquisition (SCADA) data. Although examples discussed herein utilize SCADA data for analysis, it will be appreciated that other sensor data (i.e., not SCADA data) from sensors within a wind turbine may be utilized alone or in combination with SCADA data in assessing the likelihood of damage caused by the lightning strike(s). As such, in some embodiments, sensor data may only include SCADA data. Further, in some embodiments, sensor data may include features generated from SCADA and/or non-SCADA data. In one example, sensor data may include SCADA data such as wind speed and pitch angle as well as generated features based on SCADA data (e.g., lagged rotor speed).

Anomaly detection of the sensor data (e.g., features based on SCADA and/or non-SCADA data from a wind turbine) can be achieved using statistical methods, machine learning, signal processing, and/or using a hybrid of these approaches. In some embodiments, statistical methods may include principal component analysis, Gaussian Mixture Model (GMM), and/or the like. Machine learning methods can be divided into supervised methods and unsupervised methods. Supervised methods may include, but are not limited to, neural networks, XGBoost (eXtreme Gradient Boosting), and the like. Unsupervised methods may include, but are not limited to, clustering, isolation forest, and the like.

Lightning detection service(s) 104 may include any number of systems configured to provide notifications and information regarding when and where lightning strikes are detected. For example, a lightning detection service 104 may include the Global Lightning Dataset (GLD360) provided by Vaisala. There may be any number of lightning detection services indicating when lightning strikes and the location of the lightning strike (e.g., GPS coordinates or other coordinate systems).

The power operator system 108 may be any number of digital devices that allow for operation and/or management of one or more wind turbines. The power operator system 108 may be a system associated with an owner, service provider, maintenance provider, government service, power operator, or any user authorized to access information, control or otherwise provide services associated with wind turbines and/or energy.

Although there is only one power operator system 108 depicted, it will be appreciated that there may be any number of power operator system(s) 108 that operate or manage any number of wind turbines. In one example, a first power operator 108 (e.g., a maintenance provider) may manage a first wind turbine farm 110A and a second power operator 108 (e.g., an owner) may manage a second wind turbine farm 110B. The lightning-impacted wind turbine detection system 102 may receive lightning information (e.g., amplitude and location) of lightning strikes, determine the proximity of any number of lightning strikes to wind turbines in either wind turbine farm 110A and 110B, and provide alerts to the power operator system that manages the wind turbine of concern if conditions are met (e.g., the lightning strike is within a predetermined range of the wind turbine of concern, and the wind turbine of concern is providing sensor data indicating lightning-impact related anomalies after the occurrence of the lightning strike as discussed herein). As such, it will be appreciated that the lightning-impacted wind turbine detection system 102 may provide services and support to any number of unrelated power operator systems 108 that operate or manage any number of wind turbine farms 110A-N.

The wind turbine farms 110A-N include any number of wind turbine farms. A wind turbine farm is a group of wind turbines that produce electricity. Different wind turbine farms may be located in different locations. For example, wind turbine farm 110A may be located in water and wind turbine farm 110B may be located on land.

The communication network 106 may be or include any number of networks. In one example, the communication network 106 includes or is the Internet. In some embodiments, the communication includes local area networks (LANs), general wide area networks (WANs), and/or public networks (for example, the Internet). Although FIG. 1 depicts the lightning-impacted wind turbine detection system 102, the lightning detection service(s) 104, the power operator system(s) 108, and the Wind Turbine Farms 110A-N communicating over the communication network 106, it will be appreciated that any of these systems, farms, and/or wind turbines may communicate over the same or different communication networks.

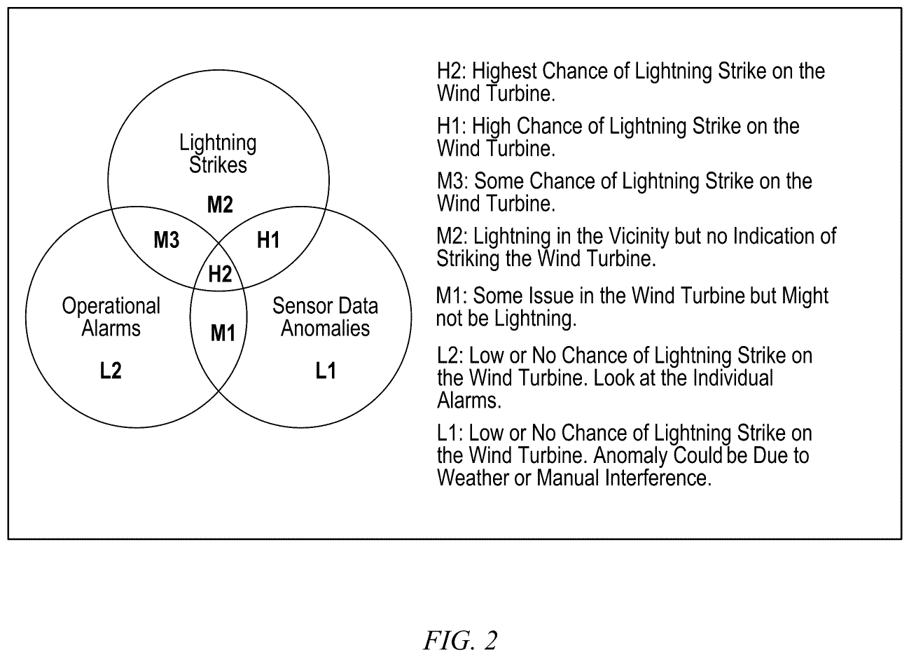

At a high level, in some embodiments, the lightning-impacted wind turbine detection system 102 may operate across two or three components. FIG. 2 depicts a Venn diagram of three overlapping components that may be used to assess the likelihood of lightning-related damage to a wind turbine in some embodiments. The highest likelihood of damage caused by a lightning impact occurs when all three components align, indicating a high confidence level (H2), which suggests that the operator should immediately shut down the turbine. In this example, a high likelihood of lightning impact arises when sensor data anomalies are detected in conjunction with high nearby lightning strike (but without operational alarms) (H1). If operational alarms related to lightning are triggered alongside a significant nearby lightning strike but without anomalies detected, the notification may indicate that there is a moderate likelihood that the wind turbine is damaged or otherwise impacted by a lightning strike (M3).

A lower severity alert occurs when operational alarms and sensor data anomalies are present simultaneously while no lightning strikes were reported (e.g., due to broken data pipeline), indicating potential issues with the turbine that may not be related to lightning (M1). If operational alarms are triggered alone, operators may receive the alarm from the lightning-impacted wind turbine detection system 102 or other system. The operator may review the specific alarm details, as they may not be related to lightning (L2). Sensor anomalies by themselves can generally be disregarded (at least with respect to determining if there is lightning-related damage), as they are often attributed to extreme wind conditions, automated tests or manual interference (L1).

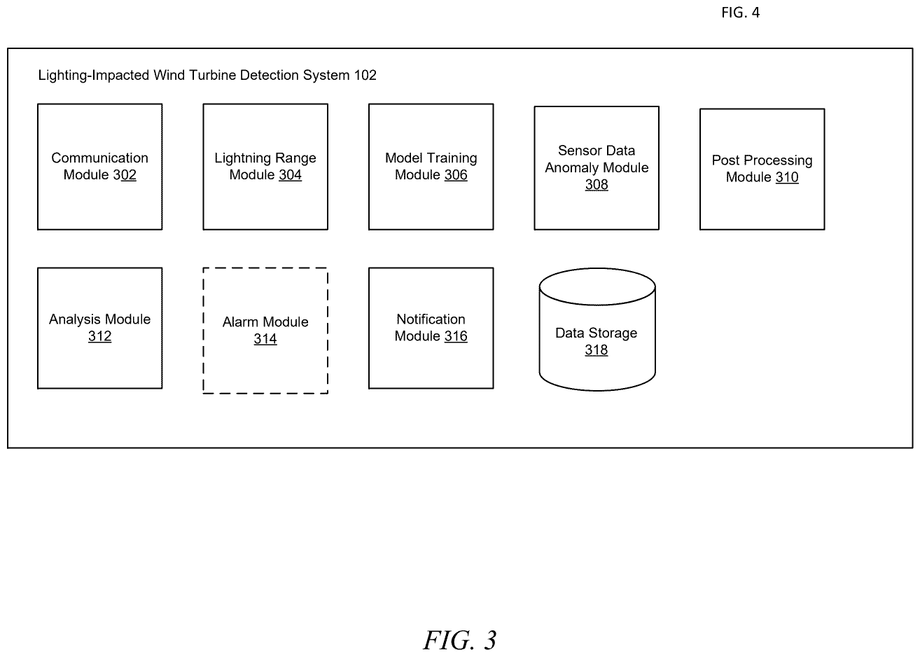

FIG. 3 depicts an example lightning-impacted wind turbine detection system 102 in some embodiments. A lightning-impacted wind turbine detection system 102 may include a communication module 302, a lightning range module 304, a model training module 306, a sensor data anomaly module 308, a post processing module 310, an analysis module 312, an optional alarm module 314, a notification module 316, and data storage 318.

As discussed herein, the lightning-impacted wind turbine detection system 102 may receive an indication of nearby lightning strikes. In one example, the communication module 302 may receive an indication on amplitude and location (e.g., estimated GPS coordinates) of a lightning strike at or near the time of the lightning strike from a lightning detection service (e.g., lightning detection service 104 in FIG. 1).

The indications of lightning strikes (e.g., reports or notifications from the lightning detection service) may include lightning data. Lightning data may include time and estimated amplitude and location of the lightning strike. In some embodiments, the lightning data may include the amplitudes (e.g., in kA) and polarities of lightning strikes. Note that the polarity of the lightning amplitude indicates the direction of the lightning strike. For example, a polarity indicating “negative” lightning is when the net transfer of negative charge is from the cloud to the ground while a polarity indicating “positive” lightning is when the net transfer of positive charge is from the cloud to the ground. Positive lightning is less common but much more lethal and causes greater damage than negative lightning.

In some embodiments, an indication of a lightning strike including amplitude and location may be provided by a lightning detection service such as the Global Lightning Dataset (GLD360) provided by Vaisala. This network provides real-time lightning detection and is capable of monitoring lightning activity across the world.

While the Vaisala network and GLD360 are referenced specifically herein, it will be appreciated that the lightning-impacted wind turbine detection system 102 may receive lightning data (e.g., location and timing of any lightning strikes) from any number of lightning detection services.

In some embodiments, the lightning range module 304 may determine an estimated proximity of the lightning strike (e.g., reported by the lightning detection service) to one or more wind turbines. For example, the lightning range module 304 may retrieve locations of wind turbines or wind turbine farms from the data storage 318. The lightning range module 304 may then determine the distance between the estimated location of the lightning strike (as indicated by the lightning information from the lightning detection service) and the closest wind turbine and/or wind turbine farm. In some embodiments, the lightning range module 304 determines the distance between the location of the lightning strike and the closest set of wind turbines (e.g., of any number of wind turbines).

The lightning range module 304 may further compare the range(s) between a location of a lightning strike and the location of any number of wind turbines to a predetermined range (e.g., a first range). In one example, based on the information from the lightning detection service, the lightning range module 304 may determine that a lightning strike of −209 kA happened within 100 meters of a wind turbine.

In some embodiments, the lightning-impacted wind turbine detection system 102 assesses sensor data of a wind turbine for lightning related damage only after a lightning event (e.g., a lightning strike) is determined (based on lightning information the lightning detection service) to be within the predetermined range. For example, based on proximity of the lightning strike to one or more wind turbines (e.g., the proximity of the lightning strike to one or more wind turbines is within or below a predetermined range), the lightning-impacted wind turbine detection system 102 may further assess sensor readings from the one or more wind turbines proximate to the lightning strike to determine if there is a likelihood of lightning-related damage.

While a lightning range module 304 is discussed herein, it will be appreciated that the lightning range module 304 may be optional. For example, the lightning detection service may receive locations of any number of wind turbines and provide ranges between any lightning strikes and any number of wind turbines. In some embodiments, the lightning detection service may provide notification of lightning strikes only when the lightning strike is within a predetermined range of known locations of one or more wind turbines. Alternately, the lightning detection service may provide a particular alert of lightning strikes when the lightning strike is within a predetermined range of known locations of one or more wind turbines and provide notifications of other lightning strikes as needed or desired.

The sensor data anomaly module 308 may receive wind turbine monitoring data from one or more wind turbines. In some embodiments, wind turbine monitoring data includes or is SCADA data, non-SCADA data, or a combination of SCADA data and non-SCADA data. In various embodiments, the wind turbine monitoring data includes sensor data and operational alarms. In some embodiments, the sensor data anomaly module 308 generates features based on SCADA and/or non-SCADA data. For example, the sensor data anomaly module 308 may generate lagged rotor speed (further discussed herein) based on rotor speed and/or other data received from sensors associated with one or more wind turbines.

It will be appreciated that the sensor data anomaly module 308 may receive wind turbine monitoring data from any number of wind turbines over time. In some embodiments, the sensor data anomaly module 308 retrieves or receives wind turbine monitoring data from a wind turbine when requested. For example, the sensor data anomaly module 308 may retrieve wind turbine monitoring data from one or more wind turbines (e.g., via a centralized source or service that collects wind turbine monitoring data from any number of wind turbines) and/or directly from the wind turbine(s) (e.g., as sensor data) when a lightning strike is determined to be within the predetermined range of the wind turbine(s).

In some embodiments, the optional alarm module 314 may receive operational alarms directly from one or more wind turbines and/or as a part of the sensor data. Similar to the sensor data anomaly module 308, the optional alarm module 314 may receive operational alarms from any number of wind turbines over time. In some embodiments, the optional alarm module 314 retrieves or receives operational alarms from a wind turbine when requested. For example, the optional alarm module 314 may retrieve operational alarms from one or more wind turbines (e.g., via a centralized source or service that collects sensor data from any number of wind turbines) when a lightning strike is determined to be within the predetermined range of the wind turbine(s).

Operational alarms in a wind turbine are alerts and warnings generated by its control system when operational conditions or parameters fall outside the predefined safety or operational limits. These alarms can indicate if there is an issue with the wind turbine, which can range from a minor operational issue to a critical fault that requires the immediate shut down of the turbine. The operational alarms of a wind turbine can be categorized into different types such as, but not limited to, over-temperature alarms, under-temperature alarms, vibration alarms, overspeed alarms, power fluctuation alarms, yaw system alarms, pitch system alarms, grid connection alarms, generator alarms, gearbox alarms, and the like. Specific examples of operational alarms (including more immediate operational alarms associated with lightning events and secondary operational alarms that occur later after the lightning event) are discussed herein.

Returning to the sensor data anomaly module 308, the sensor data anomaly module 308 may utilize a machine learning approach by utilizing trained models to categorize non-standard sensor measurements (e.g., anomalies in the sensor data) as potentially lightning-damage related sensor data.

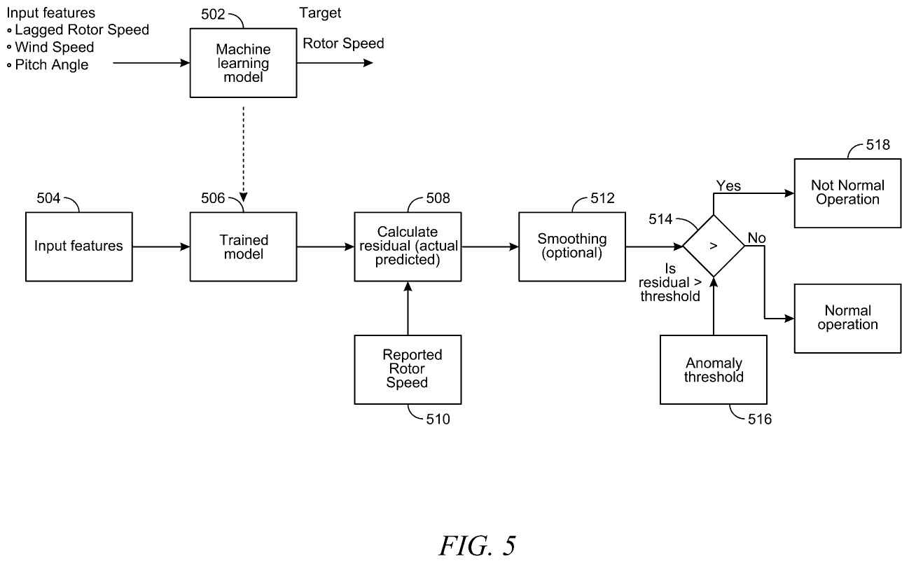

The model training module 306 may train one or more models to identify non-standard sensor data (e.g., anomalies). FIG. 5 further depicts a flowchart for training a machine learning model and evaluating sensor data (e.g., sensor measurements) from one or more wind turbines (e.g., that are proximate to lightning strikes). In this example, in step 502, a machine learning model is trained using normal operational data (i.e., no anomalies) to predict rotor speed. The input features used in this example are lagged rotor speed and both current and lagged wind speed and pitch angle data. In some embodiments, lagged rotor speed (further discussed herein) is a feature that is generated based on sensor data received from one or more wind turbines. The machine learning model may be trained to predict rotor speed using, in part, the input during a normal operation. It will be appreciated that the machine learning module may be trained to predict any sensor measurement(s), including, for example, wind speed or pitch angle. While FIG. 5 depicts that rotor speed is predicted based on input features such as lagged rotor speed, wind speed, and pitch angle, it will be appreciated that the rotor speed may be predicted based on any input features.

Lagged rotor speed, in the above example, refers to the recorded speed of a wind turbine's rotor blades that is analyzed or reviewed over time rather than immediately as the data is generated. In one example, lagged rotor speed is reviewed to understand operational trends, effectiveness of control systems, and/or potential issues that may not be immediately apparent. It will be appreciated that rotor speed directly influences power output and mechanical stress. In various embodiments, sensor data may include lagged rotor speed (e.g., the SCADA data may include lagged rotor speed). Similarly, the sensor data may include rotor speed (e.g., the SCADA data may include rotor speed). In some embodiments, the lagged rotor speed may be determined or generated based on sensor data (e.g., by the sensor data anomaly module 308).

Lagged wind speed, in the above example, refers to the measurement of wind speed that is analyzed or reviewed over time rather than immediately as the data is generated. In one example, lagged wind speed may be analyzed and reviewed to evaluate wind patterns and turbine performance over time. It will be appreciated that lagged wind speed allows for a retrospective analysis of how wind conditions have varied over time (with respect to a particular wind turbine or wind turbine farm) and can allow projections of output efficiency as well as the reduction of mechanical stress under varying wind speeds. In various embodiments, sensor data may include lagged wind speed (e.g., the SCADA data may include lagged wind speed). Similarly, the sensor data may include wind speed (e.g., the SCADA data may include wind speed). In some embodiments, the lagged wind speed may be determined or generated based on sensor data (e.g., by the sensor data anomaly module 308).

In some embodiments, the model training module 306 receives sensor data from one or more wind turbines operating under healthy conditions. As discussed herein, the sensor data may be lagged rotor speed, current wind speed, lagged wind speed, and pitch angle data. While lagged rotor speed, current wind speed, lagged wind speed, and pitch angle data are discussed herein, it will be appreciated that any sensor data may be utilized.

The model training module 306 may train a model based on these input features to provide a target rotor speed. As discussed herein, the model training module 306 may train a model based on input features to provide any target performance metric (e.g., not limited to target rotor speed). Further, any model may be utilized in conjunction with the systems and methods described herein.

The sensor data anomaly module 308 may utilize the model trained by the model training module 306 to identify lightning-related anomalies in the sensor data. For example, the sensor data anomaly module 308 may apply one or more features (e.g., lagged rotor speed, wind speed, and pitch angle) from sensor data to the trained model to predict a rotor speed (e.g., output from the model), and calculate a residual (e.g., a difference between the predicted and actual rotor speed of the wind turbine). In various embodiments, the sensor data anomaly module 308 only receives and/or applies the input features of a particular wind turbine when lightning information indicates that there was a lightning strike within a predetermined range from the wind turbine. Lightning-related anomalies include or are non-standard performance correlated with lightning impact.

The optional post processing module 310 may process the residual (e.g., smoothing) or apply other functions as needed to the residual. In some embodiments, the residual is not processed or smoothed before the analysis module 312 compares the residual to an anomaly threshold.

The analysis module 312 may compare the residual to the anomaly threshold to determine if there is normal operation or an anomaly indicating non-standard performance related to lightning damage that may be sufficient to trigger an alert. The anomaly threshold may be determined based on historical data and/or set by a user depending on their sensitivity to damage, the age of the wind turbine(s), and/or the like. If the residual is outside the anomaly threshold, this is an example of non-standard performance correlated to lightning impact.

The optional alarm module 314 may determine if the wind turbine of concern has generated operational alarms of concern (e.g., see alarms indicated in tables III and IV below) after a report indicating that there has been a lightning strike proximate to the wind turbine.

The alarm module 314 may be optional. It will be appreciated that operational alarms generally depend upon the operating system and configuration of the operating system. As such, alarms may be inconsistently generated or there may be different alarms generated for different reasons for different wind turbines operating with different operating systems.

The notification module 316 may generate an alert or notification based on the conditions indicated in FIG. 2. For example, if a lightning strike is reported within a predetermined range of a particular wind turbine and the wind turbine is generating sensor data that is assessed to be both anomalous and optionally correlated with possible lightning damage (e.g., see FIG. 5) after the lightning strike was reported to happen, then the notification module 316 may provide an alert to a user, operator, and/or the like. In some embodiments, the alert is provided to a dashboard indicating what caused the alarm (e.g., information regarding time of the strike and range from the wind turbine, the anomalous conditions, any alarm conditions, and/or the like). In some embodiments, the notification module 316 may retrieve recommendations or guidelines depending on the anomalous conditions and the wind turbine. For example, the data storage 318 may include recommendations and/or guidelines for different conditions (e.g., depending upon the anomalous and/or wind turbine in question).

In some embodiments, the notification module 316 may trigger a notification based on any number of different conditions. A user may, for example, configure the notification module 316 based on the system's, operator's, and/or user's sensitivity to risk. As such, the user may adjust alarm conditions, predetermined ranges, and/or the like as needed. In some embodiments, a user may configure the notification to generate alerts for conditions related to one or more wind turbines and alerts for different conditions related to other wind turbines. For example, one set of wind turbines may be older, suspected of previous damage, and/or serving a critical population. In this example, the user may configure the notification module 316 to generate an alert under a much broader set of conditions (e.g., with greater predetermined ranges, smaller anomaly thresholds, and/or the like) because they are far more sensitive to risk for this set of wind turbines. The same user may configure the notification module 316 to generate an alert under a much stricter set of conditions (e.g., with smaller predetermined ranges, larger anomaly thresholds, and/or the like) for another set of wind turbines that are newer, have lightning protection systems, and/or do not serve critical populations. As such, the user may configure the first range (e.g., the predetermined range between the reported estimated location of the lightning strike and a wind turbine) to a greater or lesser range depending on need, sensitivity to risk, type of wind turbine, protection systems, and/or any other factors.

For example, a user may configure the notification module 316 to trigger an alarm if a lightning strike is reported within a first range, if the lightning strike is at or above a particular amplitude, and if sensor data is received from that particular wind turbine is determined to be non-standard (e.g., anomalous as assessed in FIG. 5). Similarly, the user may configure the same notification module 316 to trigger an alarm if a lightning strike is reported within a second range (e.g., the second range being closer to the wind turbine than the first range) regardless of amplitude and if sensor data is received from that particular wind turbine is determined to be non-standard (e.g., anomalous as assessed in FIG. 5). In this example, the notification module 316 may trigger an alarm, based in part, if the lightning strike is at a first range if the amplitude and/or polarity is above a particular intensity threshold or if the lightning strike is at a closer range to the wind turbine regardless of amplitude and/or polarity. Alternately, a user may configure the notification module 316 to trigger an alarm if the lightning strike is within a particular range of a wind turbine, if sensor data is received form that particular wind turbine is determined to be non-standard, and if particular operational alarms from or associated with the particular wind turbine (e.g., one or more operational alarms from Table III and/or IV) are received.

The data storage 318 may be any data storage such as one or more table(s), database(s), block chain(s), and/or the like. In some embodiments, the data storage 318 may store a different trained model for every wind turbine. Alternately, the data storage 318 may include a model for a plurality of wind turbines (e.g., a model for a type of wind turbine, manufacturer, age, past maintenance, and/or the like).

In various embodiments, the notification module 316 may store lightning information from lightning detection service(s), model(s), features applied to the models, output from the models (e.g., residuals), comparisons of the residuals to thresholds, notification messages, operational alarms, determined ranges between the lightning strike and the wind tower(s), and/or the like to provide information sufficient for an audit or review of all information received, decisions made, and outputs provided including when and how notifications occurred.

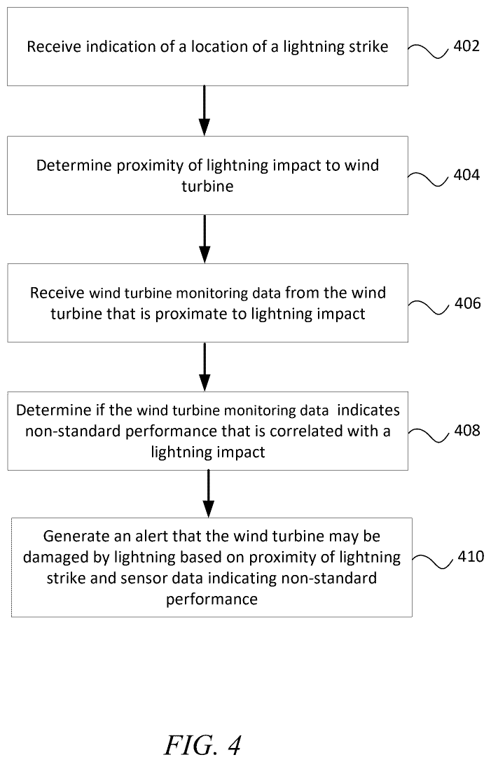

FIG. 4 is a flowchart for detecting lightning-impacted wind turbines using operational data and providing alerts in some embodiments. In step 402, the communication module 302 receives a lightning strike alert. In one example, the communication module 302 receives a report including an indication of a location of a lightning impact from a lightning detection service. In some embodiments, the lightning strike alert includes an indication of an amplitude and location of the lightning strike. The report may include lightning impact information. Lightning impact information may include a time the lightning detected occurred and a location. The location could be, for example, GPS coordinates or a range to one or more wind turbines. The lightning impact information may be provided by a lightning detection service as discussed herein. In some embodiments, the lightning impact information is provided in real time or soon after the lightning impact (e.g., strike) was detected by the lightning detection service.

In step 404, the lightning range module 304 determines if the lightning strike occurred within a predetermined range of one or more wind turbines. In one example, the lightning range module 304 receives the coordinates of the lightning impact from the lightning impact information and determines distances between the coordinates and any number of wind turbines.

In some embodiments, the lightning detection service may provide an estimated location and amplitude of a lightning impact (e.g., the location is accurate to within a particular range). It will be appreciated that different lightning detection services may provide estimates of various accuracies for different ranges. The lightning range module 304 may consider that estimate in view of the location reported of the lightning strike and change the predetermined range accordingly (e.g., the predetermined range being between the lightning strike and the wind turbine that may suggest that the wind turbine was damaged due to the lightning). The lightning range module 304 may determine or retrieve the range of accuracy for that particular lightning detection service that provided in the lightning information and alter a predetermined range between the lightning strike and one or more wind turbines based on all or a portion (e.g., half) of the range of accuracy.

In some embodiments, the lightning range module 304 is optional. For example, the lightning detection service may provide estimates or ranges between detected lightning strikes and any number of wind turbines. Further, in various embodiments, the lightning detection service may only provide alerts and/or lightning information if lightning is detected within the predetermined range of one or more wind turbines (e.g., a user or operator configures an account of the lightning detection service such that alerts are provided in real time only when a lightning strike is detected within the predetermined range).

In step 406, the communication module 302 receives or retrieves wind turbine monitoring data from the wind turbine that is within the predetermined range of the location of the lightning impact (e.g., based on the lightning strike being within the predetermined range of the wind turbine). In some embodiments, the communication module 302 retrieves wind turbine monitoring data that includes sensor data (e.g., sensor measurements) of the wind turbine that is within the predetermined range of the detected lightning strike. The sensor data may be SCADA data, may include SCADA data, or may not include SCADA data. In various embodiments, the communication module 302 only retrieves or receives sensor data from a particular wind turbine when it is within the predetermined range of the lightning strike. In other embodiments, the communication module 302 may retrieve or receive sensor data from a particular wind turbine regardless of whether it is within the predetermined range of the lightning strike, however the sensor data is not assessed for lightning-related damage unless the wind turbine that provided the sensor data is within the predetermined range of the lightning strike.

The wind turbine monitoring data may include sensor data, operational alarms, or both. In one example, the sensor data only includes operational alarms. In this example, the analysis module 312 may assess the operational alarms to determine if the operational alarms are associated with possible lightning damage (e.g., see Table III and IV below).

In step 408, the analysis module 312 determines if sensor data from the wind turbine that is within range of the reported lightning impact indicates non-standard performance that may correlated with the lightning impact (e.g., the lightning strike reported in the lightning impact information). An example of an assessment of sensor data as being non-standard and correlated with a possible lightning strike is discussed with regard to FIG. 5.

In some embodiments, the sensor data may include sensor measurements of the particular wind turbine that is within the predetermined range of the lightning strike and operational alarms. The analysis module 312 may assess the sensor measurements for lightning related anomalies and assess the operational alarms that are correlated with (e.g., may be triggered by) lightning related damage.

In various embodiments, anomalies in sensor data may be related to lightning damage are determined using one or more machine learning models. Each wind turbine may have their own machine learning model that is retrieved when that particular wind turbine is determined to be within the predetermined range of a lightning strike. Alternately, a machine learning model may be used for multiple wind turbines (e.g., a single machine learning model may be used for all wind turbines of a particular age, that use a particular software, that share mechanical attributes, that have similar (e.g., type and function) gear boxes, and/or the like.

FIG. 5 further depicts a flowchart for training a machine learning model and evaluating sensor data (e.g., sensor measurements) from one or more wind turbines (e.g., that are proximate to lightning strikes). In step 502, a machine learning model is trained. As discussed herein, the model training module 306 may train one or more models to identify non-standard sensor data (e.g., anomalies). FIG. 5 depicts an approach to training machine learning models to identify or predict non-standard sensor data that is related to lightning-related damage to the wind turbines in some embodiments. In step 502, a machine learning model is trained using normal operational data (i.e., no lightning-related anomalies in the measurement data applied as input to the model) to predict rotor speed. The input features used in this example are lagged rotor speed and both current and lagged wind speed and pitch angle data. The machine learning model is either trained to minimize the residual (i.e., the difference between the predicted rotor speed and actual rotor speed) or trained to learn statistical data distribution during the normal operation.

As discussed herein, in some embodiments, the model training module 306 receives sensor data from one or more wind turbines operating under healthy conditions. As discussed herein, the sensor data may be lagged rotor speed, current wind speed, lagged wind speed, and pitch angle data. While lagged rotor speed, current wind speed, lagged wind speed, and pitch angle data are discussed herein, it will be appreciated that any sensor data may be utilized.

The model training module 306 may train a model based on these input features to provide a target rotor speed. As discussed herein, the model training module 306 may train a model based on input features to provide any target performance metric (e.g., not limited to target rotor speed). Further, any model may be utilized in conjunction with the systems and methods described herein.

Models for anomaly detection are created and validated using different approaches. In one example, models may be created and/or validated using two approaches 1) GMM and/or 2) XGBoost based machine learning model. In some embodiments, the XGBoost model is implemented as follows: Python XGBoost library is used for the training, which requires each input predictor to be a column in a python dataframe. In one example, there may be an XGBoost model for each wind turbine. In one example, the following hyper-parameters are examples shown in Table I below.

TABLE I
HYPER-PARAMETERS OF THE XGBOOST MODEL

| | |
|---|---|
| n estimators | 1000 |
| max depth | 5 |
| learning rate | 0.01 |
| subsample | 1 |
| colsample bytree | 0.8 |

In one example, the model training module 306 may train the machine learning model to predict the rotor speed using the lagged rotor speed, and both lagged and current wind speed and average pitch angle on a particular wind turbine (e.g., historical data) or a plurality of wind turbines.

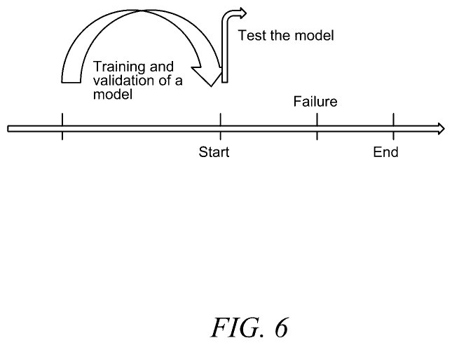

FIG. 6 depicts a graph showing the validation and testing of the model in some embodiments. The model may be validated against known historical data of healthy wind turbines by comparing the target rotor speed (and/or any other outputs of the model) to sensor readings of healthy performance over time (e.g., actual rotor speed as provided by sensors readings). The model may also be validated against historical data of wind turbines that have been struck or impacted by a lightning strike.

The performance of the model may be evaluated. In one example, the performance of lightning-impacted wind turbine detection system 102 is evaluated using the following metrics. The recall is calculated as follows:

$$Recall = \frac{T P}{T P + F N}$$

where TP is the true positive cases (i.e., damaged turbines that are correctly alerted) and FN is the false negative cases (i.e., damaged turbines that are not alerted). The precision is calculated using:

$$Precision = \frac{T P}{T P + F P}$$

where FP is the false positive cases (i.e., false alerts from the approach). The F1-score is given by:

$$F 1 - score = \frac{2 * Recall * Precision}{Recall + Precision}$$

Once a model is created and verified, the model may be used to generate a predicted sensor measurement (e.g., rotor speed) for comparison to actual rotor speed using sensor measurements from the particular wind turbine that were generated at and/or after the time the lightning strike occurred (i.e., the lightning strike that occurred within the predetermined range to the particular wind turbine). Although rotor speed is predicted in FIG. 5 using the model, it will be appreciated that the model may be trained and utilized to provide predictions of any number of sensor measurements that may or may not include rotor speed.

Returning to FIG. 5, in step 504, the communication module 302 receives and/or retrieves input features. In various embodiments, the communication module 302 receives sensor data (e.g., SCADA data and/or other sensor data) of a particular wind turbine that is proximate (e.g., within a predetermined range) of a lightning strike. In some embodiments, the communication module 302 receives sensor data and the sensor data anomaly module 308 may generate one or more features based on the sensor data (e.g., lagged rotor speed) for input to the model in step 506.

The communication module 302 may receive a notification of a lightning strike from a lightning detection service and the lightning range module 304 may determine that the location of the lightning strike (e.g., as identified in the notification of a lightning strike) is within a predetermined range of the wind turbine. In some embodiments, the communication module 302 may retrieve or receive sensor measurements upon determining that the lightning strike occurred within the predetermined range of at least one wind turbine (e.g., the sensor measurements being from the same wind turbine that was within the predetermined distance to the lightning strike).

The sensor measurements may be processed or otherwise assessed to retrieve or generate features for input to the trained model in step 504. In this example, the measurements may be used as features or generated into features that are related to rotor speed. It will be appreciated that any number of features may be provided to the trained model and/or any number of features may be engineered or created based on sensor measurements from the wind turbine. The engineered and/or created features may be provided in addition to or instead of any sensor measurements.

In step 506, the trained model may provide a prediction of rotor speed based on the input features.

In step 508, the analysis module 312 may compare the predicted rotor speed from the model to the actual or reported rotor speed of the wind turbine. In various embodiments, one or more sensors may report measurements of rotor speed and that information may be provided to the communication module 302 and/or the analysis module 312 in step 510. The measurements of rotor speed and/or rotor speed itself (e.g., determined by the wind turbine, sensor of the wind turbine, or SCADA service)) may be compared to the predicted rotor speed.

In one example, the comparison of the predicted rotor speed from the model to the actual rotor speed of the wind turbine (e.g., the difference) creates a residual value. In some embodiments, the residual is expected to increase if there is an anomaly in the data.

Returning to step 410 in FIG. 4, the notification module 316 generates an alert or notification that the wind turbine may be damaged by lightning based on the proximity of the lightning strike and assessment of sensor data indicating non-standard performance. In some embodiments, the notification module 316 generates an alert or notification that the wind turbine may be damaged by lightning based on the proximity of the lightning strike and assessment of sensor data indicating non-standard performance and the non-standard performance is correlated with lightning damage (e.g., correlation with lightning damage is based on the residual is outside the anomaly threshold).

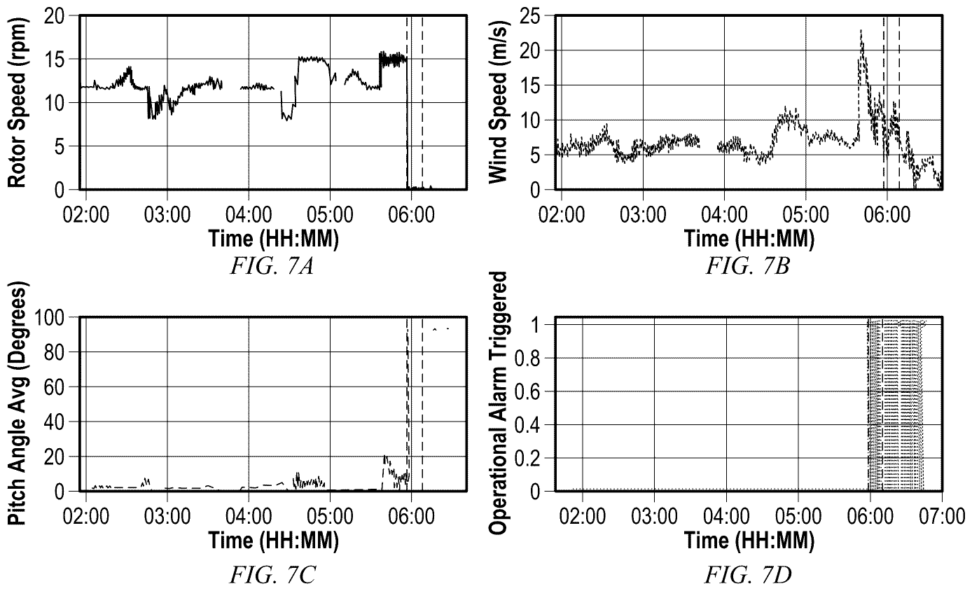

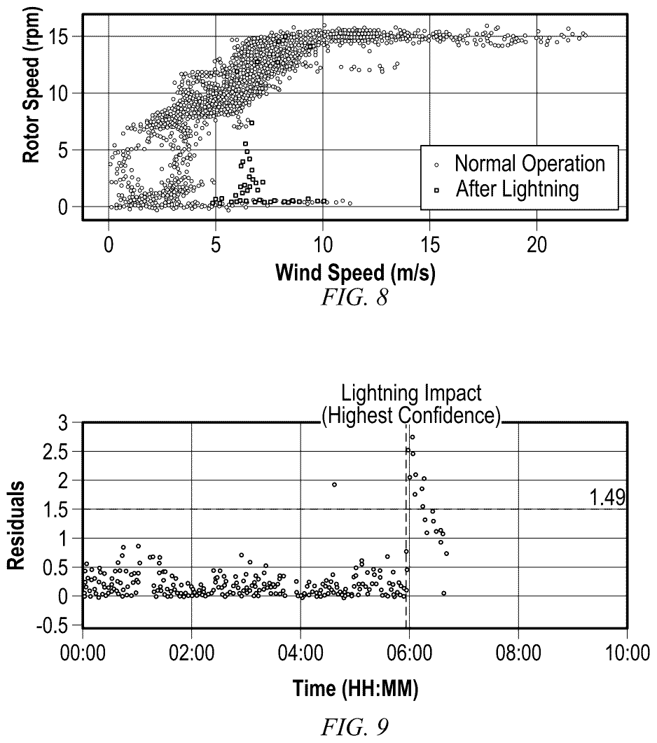

FIG. 7A-7D depicts four graphs including sensor measurements from wind turbines over the same period of time in one example. A first graph in FIG. 7A depicts rotor speed over time with the two lines indicating two lightning strikes proximate to the wind turbine. A second graph in FIG. 7B depicts wind speed over time with the two lines indicating two lightning strikes proximate to the wind turbine. A third graph in FIG. 7C depicts pitch angle average (in degrees) over time with the two lines indicating two lightning strikes proximate to the wind turbine. A fourth graph in FIG. 7D depicts operational alarms triggered over time with the two lines indicating two lightning strikes proximate to the wind turbine. FIG. 8 depicts a plot graph of rotor speed to wind speed including normal operation as compared to the wind turbine rotor speed to wind speed after a lightning strike. FIG. 9 depicts a graph showing an example where the residual increased exactly after the lightning event at 05:56:45 (HH:MM:SS) indicating an anomaly in operational data.

In optional step 512, the comparison of the predicted rotor speed to actual (or measured) rotor speed (e.g., the residual) may be optionally smoothed by the post processing module 310. Smoothing the data may assist to determine if the comparison of the predicted rotor speed to the actual (or measured) rotor speed is within a predetermined anomaly threshold.

In step 514, the sensor data anomaly module 308 may compare the calculated residual (e.g., predicted rotor speed to the actual (or measured) rotor speed) to the predetermined anomaly threshold. The anomaly threshold may be generated based on statistical analysis of historical anomalies related to lightning damage and/or a user may provide the anomaly threshold in step 516.

In various embodiments, if the model provides a prediction of rotor speed that is sufficiently different from the actual or reported rotor speed, then non-standard performance is detected. The non-standard performance may be correlated to a lightning strike if the difference (e.g., the residual) is larger than the anomaly threshold.

If the compared predicted rotor speed to the actual (or reported) rotor speed is within (e.g., not greater than) the predetermined anomaly threshold, then the notification module 316 may not provide an alert or notification. If, however, the compared predicted rotor speed to the actual (or measured) rotor speed is outside of (e.g., equal to or greater than) the predetermined anomaly threshold, then the notification module 316 may provide an alert or notification to an operator or user indicating a likelihood of lightning-related damage in step 518.

In some embodiments, sensor data indicating non-standard performance may be compared to the output of the model (e.g., target rotor speed) after a possible impact by a lightning strike (e.g., comparing the target rotor speed to a rotor speed that is non-standard). Differences of target to actual performance metrics may further indicate possible lightning damage (e.g., particularly after a lightning impact within the predetermined range of the wind turbine providing the sensor measurements and/or alerts).

In some embodiments, the trained model is tested during real-time operation as shown in FIG. 5. The residual is expected to increase when there are anomalies in the operational data caused by or correlated with lightning striking the wind turbine and/or other abnormal operational conditions. The anomalies may also appear during a manual turbine shut down.

Returning to FIG. 4, the notification module 316 may generate an alert that the wind turbine may be damaged by lightning based on the proximity of the lightning strike and sensor data indicating a non-standard performance. Non-standard performance may include, for example, anomalous data detected (or determined) by the analysis module 312 (as discussed with regard to FIG. 5 herein).

In some embodiments, notifications and alerts may be triggered based on sensitivity that may be manually set by a user. As shown in FIG. 2, a user may set the sensitivity and thresholds when to trigger an alert or notification. For example, the user may determine that only alarms of those in category H2 (only the highest chance of damage when the three components align) are to be assessed by the lightning-impacted wind turbine detection system 102 when conditions are met as discussed herein (e.g., there is an indication of a proximate lightning impact). In this example, other alarms may be generated but may not be assessed by the lightning-impacted wind turbine detection system 102. Alternately, the user may configure the lightning-impacted wind turbine detection system 102 to assess alarms only in category H1 when there is an overlap of at least one lightning strike proximate to the wind turbine and the same wind turbine is indicating, via sensor data, that there are sensor data anomalies.

As discussed herein, an operator can alter the sensitivity or meaning of alerts. For example, the lightning-impacted wind turbine detection system 102 may provide a notification when the highest likelihood of a lightning impact occurs when all three components align as indicated above (e.g., proximate lightning strike, sensor data indicates anomaly, and operational alarms indicates substandard performance (or particular operational alarms are present). The operator, however, may configure the lightning-impacted wind turbine detection system 102 such that when data anomalies are detected in conjunction with a high nearby lightning amplitude, then there is a high likelihood that the wind turbine is damaged or otherwise impacted by a lightning strike (H1). Similarly, the operator may configure the lightning-impacted wind turbine detection system 102 such that when sensor data anomalies are detected in conjunction with certain operational alarms correlated with lightning strikes, then there is a moderate likelihood that the wind turbine is damaged or otherwise impacted by a lightning strike (M1).

The following are examples of operational alarms that are correlated with lightning strikes and, as such, may be triggered after a lightning impact. It should be noted that alarms related to pitch angles and main shaft are more frequent immediately after a lightning strike. Further, it may be noted from the data (and models may identify) that alarms related to automated pitch angle tests are more frequent two minutes after a lightning strike.

TABLE II
includes historical lightning damage events with the severity of the damage specified.

| | | Inspection | Lightning | Lightning | Distance to | Time to |
|---|---|---|---|---|---|---|
| Turbine | Lightning | date | strikes | amplitude | lightning | detection |
| ID | date | & severity | timestamps utc | (kA) | (m) | (days) |
| A | 2021-09-27 | 2021-09-29, category 5 | 2021-09-27 19:02:33 | -118 | 138 | 2 |
| B | 2022-08-29 | 2022-08-29, category 5 | 2022-08-29 17:07:38 | -209 | 100 | 0 |
| C | 2020-07-26 | 2021-02-03, category 5 | 2020-07-26 21:12:40 | -107 | 128 | 192 |
| | | | 2020-07-26 21:12:40 | -58 | 58 | |
| D | 2021-08-11 | 2021-08-13, category 5 | 2021-08-11 14:55:56 | -104 | 159 | 2 |
| | | | 2021-08-11 14:55:56 | -50 | 42 | |
| F | 2021-05-19 | 2022-03-29, category 5 | 2021-05-19 15:18:22 | -164 | 34 | 314 |
| | | | 2021-05-19 15:18:22 | -52 | 677 | |
| F | 2021-08-17 | 2021-08-25, category 5 | 2021-08-17 11:26:08 | -143 | 838 | 8 |
| | | | 2021-08-17 11:29:20 | -161 | 359 | |
| G | 2022-08-04 | 2023-08-30, category 5 | 2022-08-04 09:23:37 | -55 | 31 | 391 |
| H | 2023-06-22 | 2023-07-23, category 5 | 2023-06-22 22:53:36 | 102 | 64 | 31 |
| | | | 2023-06-22 22:59:38 | 191 | 410 | |
| I | 2023-08-01 | 2023-08-01, category 5 | 2023-08-01 05:56:45 | 321 | 220 | 0 |
| | | | 2023-08-01 06:08:06 | 264 | 780 | |
| J | 2021-09-30 | 2022-01-12, category 5 | 2021-09-30 06:55:26 | -84 | 275 | 104 |
| | | | 2021-09-30 06:57:09 | -95 | 972 | |
| K | 2020-07-26 | 2021-02-03, category 5 | 2020-07-26 21:07:43 | -49 | 86 | 192 |
| | | | 2020-07-26 21:07:43 | -35 | 48 | |
| L | 2022-01-09 | 2023-04-13, category 5 | 2022-01-09 21:11:56 | -70 | 277 | 459 |
| | | | 13 lightning strikes | 4 of them > | | |
| | | | | 50 kA | | |
| M | 2022-04-29 | - | 2022-04-29 12:43:27 | 127 | 601 | 0 |
| N | 2022-06-28 | 2023-04-09, category 3 | 2022-06-28 20:08:03 | -79 | 71 | 285 |
| O | 2024-05-08 | 2024-05-08, category 4 | 2024-05-08 18:59:09 | -62 | 71 | 0 |
| P | 2021-05-12 | 2022-01-21, category 4 | 2021-05-12 04:17:52 | -41 | 409 | 254 |
| | | | 2021-05-12 04:34:50 | -57 | 109 | |
| Q | 2021-07-28 | 2023-10-20, category 4 | 2021-07-28 18:26:25 | -60 | 298 | 652 |
| | | | 2021-07-28 18:26:25 | -56 | 198 | |
| R | 2021-10-20 | 2021-10-22, category 4 | 2021-10-20 20:48:57 | 136 | 142 | 2 |
| S | 2021-09-29 | 2022-04-13, category 5 | 2021-09-29 16:42:24 | -54 | 234 | 196 |
| T | 2024-04-20 | - | 2024-04-20 21:47:48 | -32 | 29 | - |
| U | 2024-08-15 | - | 2024-08-15 05:25:21 | -74 | 54 | - |
| V | 2024-05-11 | - | 2024-05-11 21:49:37 | -243 | 385 | - |
| W | 2024-07-14 | - | 2024-07-14 18:11:30 | -33 | 45 | - |
| X | 2024-08-09 | - | 2024-08-09 05:59:33 | -73 | 61 | - |
| Y | 2024-05-01 | - | 2024-05-01 05:09:55 | -84 | 201 | - |
| Z | 2022-09-02 | 2023-05-04 category 3 | 2022-09-02 21:26:18 | -91 | 374 | 244 |

TABLE III depicts immediate alarms after a lightning strike.

| | | Case number and |
|---|---|---|
| | | (time in seconds after |
| Alarm ID | Alarm description | the lightning strike) |
| 1 | MainShaftError | A (7 s), B (7 s), |
| | | E (7 s), I (7 s) |
| | | V (10 s) |
| 2 | Frequency error, out of | I (22 s), * (5 s) |
| | electrical specification | |
| 3 | GearboxBearingTempSensorFail | H (4 s) |
| 4 | Pitch deviation | H (3 s) |
| 5 | RotorTachSpdSigErr | F (20 s), L (21 s), |
| | | R (25 s) |
| 6 | PitchA step: | D (15 s), P (4 s) |
| 7 | PitchB step: | J (17 s) |
| 8 | PitchC step: | S (8 s) |
| 9 | Pitch pos A meas.signal fault | G (17 s), Q (22 s), |
| | | T (4 s), X (32 s) |
| 10 | Pitch pos B meas.signal fault | K (11 s) |
| 11 | Pitch pos C meas.signal fault | C (5 s), U (6 s), |
| | | W (40 s), Z (5 s) |
| 12 | Tow. acc. X/Y fault m/s² | M (20 s) |
| 13 | | |
| 14 | ExtHighPwrAct:_{——}kW | N (7 s), O (5 s), |
| | | Y(8 s) |

TABLE IV depicts secondary alarms after a lightning strike.

| | | Case number and |
|---|---|---|
| | | (time in seconds after |
| Alarm ID | Alarm description | the lightning strike) |
| 15 | Ex low voltage | I (2 m) |
| 16 | PitchAccumulatorTestAccFailed | C (5 m) |
| 17 | Pitch accu. test active | D (6 m), F (40 m), G(3 m), |
| | | J (2 m), N (2 m), O (3 m), |
| | | Q (11 m), T (2 m), U (2 m), |
| | | W (2 m), X (3 m), Y (4 m), |
| | | Z (9 m) |
| 18 | Pitch valves test active | D (3 m), F (40 m), G (3 m), |
| | | J (2 m), N (2 m), O (3 m), |
| | | Q (13 m), T (4 m), U (4 m), |
| | | W (4 m), X (4 m), Y (7 m), |
| | | Z (7 m) |
| 19 | ECM valves test active | D (2 m), F (50 m), G (6 m), |
| | | J (5 m), N (6 m), Q (15 m), |
| | | T (6 m), U (6 m), W (7 m), |
| | | X(7 m), Z (11 m) |
| 20 | Rotor: . RPM | F (36 m) |
| 21 | EMF Acc Press Low | F (43 m) |
| 22 | EMCV.Pitch min: | Q (2 m) |
| 23 | Pilot pressure low | T (7 m) |

Table III depicts an example list of operational alarms that may be generated by a wind turbine operation system immediately after a lightning impact (e.g., 3-22 seconds after a lightning impact). It will be appreciated that the alarms may be generated at any time after the lightning impact (e.g., 1-10 seconds or 3-50 seconds). Further, although one or more of these alarms may be generated when there is no indication of a lightning impact or no indication of a lightning impact within the predetermined range of the wind turbine, those particular alarms may not be identified as being associated with lightning impact.

The list of operational alarms in Table III are examples of alarms that have been identified as being associated with lightning impacts when they are generated near the time of a reported, proximate lightning impact. It will be appreciated that there may be fewer or more alarms beyond those identified in Table II.

Similarly, one or more of the “secondary” alarms are associated with a lightning strike if any of the alarms in table IV first appear within 2-60 minutes of a lightning strike as reported by the lightning information that is within a predetermined distance of the wind turbine.

Table IV depicts an example list of “secondary” operational alarms that may be generated by a wind turbine operation system at some time after a lightning impact (e.g., 2-60 minutes after a lightning impact). It will be appreciated that the alarms may be generated at any time after the lightning impact (e.g., 1-50 minutes or 2-90 minutes). Further, as discussed with regard to the alarms discussed in Table III, although one or more of the alarms identified in Table III may be generated when there is no indication of a lightning impact or no indication of a lightning impact within the predetermined range of the wind turbine, those particular alarms may not be identified as being associated with lightning impact.

The list of operational alarms in Table IV are examples of alarms that have been identified as being associated with lightning impacts when they are generated near the time of a reported, proximate lightning impact. It will be appreciated that there may be fewer or more alarms beyond those identified in Table IV.

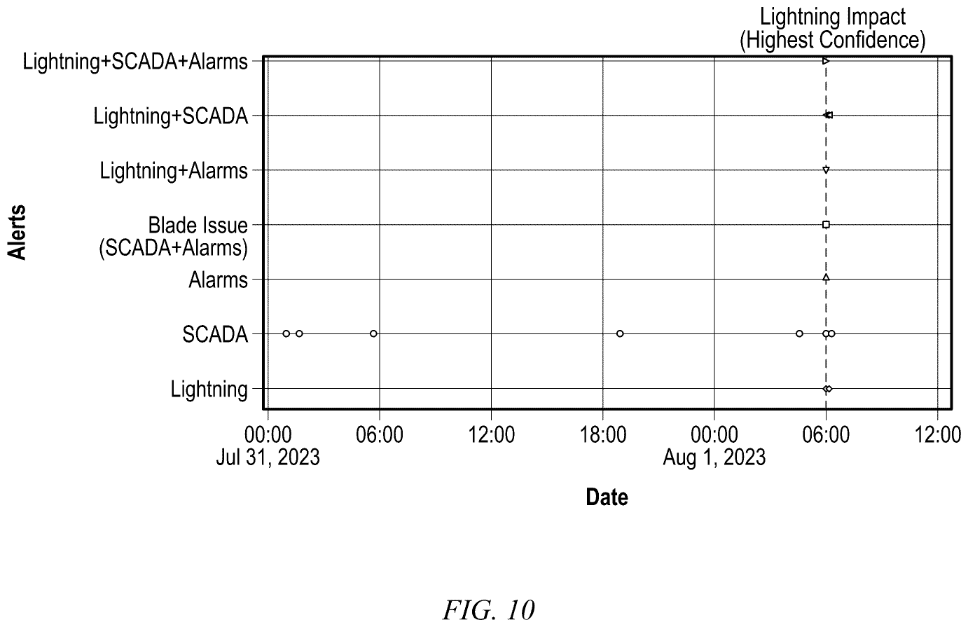

FIG. 10 depicts a graph of lightning-impacted wind turbine detection system alerts over time for a wind turbine in one example.

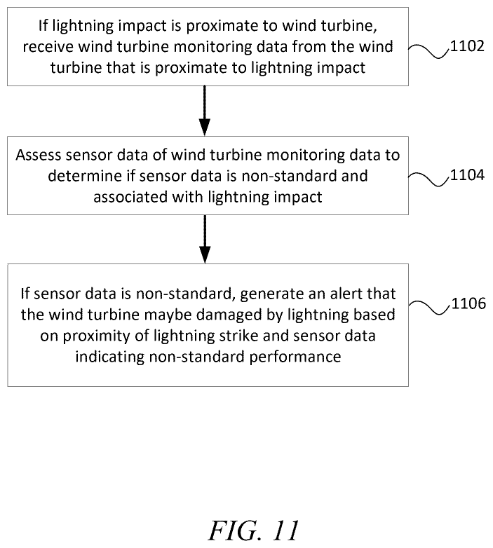

FIG. 11 is a flowchart of a process for generating an alarm (e.g., notification) of possible lightning related damage based on the determination of non-standard performance in some embodiments. In this example, the communication module 302 receives lightning impact information from a lightning detection service. The lightning impact information includes location and time of a lightning strike. In some embodiments, the lightning impact information may include a magnitude and/or a polarity of the lightning strike.

The lightning range module 304 may, as discussed with regard to FIG. 3, determine if the lightning strike occurred within a predetermined range of a wind turbine. For example, in step 1102 of FIG. 11, the communication module 302 may receive or review wind turbine monitoring data if the lightning impact (e.g., the lightning strike) is proximate (e.g., within the predetermined range) of a particular wind turbine. In some embodiments, sensor data from the wind turbine monitoring data may be assessed or reviewed for possible lightning damage only if a lightning strike is at or within the predetermined range. In some embodiments, the wind turbine monitoring data is not retrieved from the wind turbine until a lightning strike is reported to be within the predetermined range of the particular wind turbine or the wind turbine monitoring data is not assessed for lightning impact until a lightning strike is reported to be within the predetermined range of the particular wind turbine.

In step 1104, the analysis module 312 may assess the sensor data (e.g., sensor measurements) to determine if the sensor measurements are non-standard relative to healthy sensor measurements obtained in the past when the wind turbine (or a similar wind turbine) was healthy. In various embodiments, the analysis module 312 trains and utilizes a model as described with regard to FIG. 5. Non-standard sensor data (e.g., non-standard sensor measurements) includes data that is considered to be anomalous as discussed with regard to FIG. 5.

In step 1106, the notification module 316 generates and provides an alarm if anomalous data is detected and/or determined in step 1104. Since, in this example, the sensor measurements are not assessed unless there is a lightning strike detected within a predetermined distance to the wind turbine and only sensor data that is generated at or after the time of the lightning strike is assessed, the notification module 316 generates an alarm in this example if two conditions are met: (1) there is a lightning strike within the predetermined range of the wind turbine, and (2) sensor data obtained at or soon after the time of the lightning strike (e.g., as discussed with regard to FIG. 5) from the wind turbine is assessed to be anomalous. In this example, operating alarms are not considered for generating a notification of possible lightning-related damage.

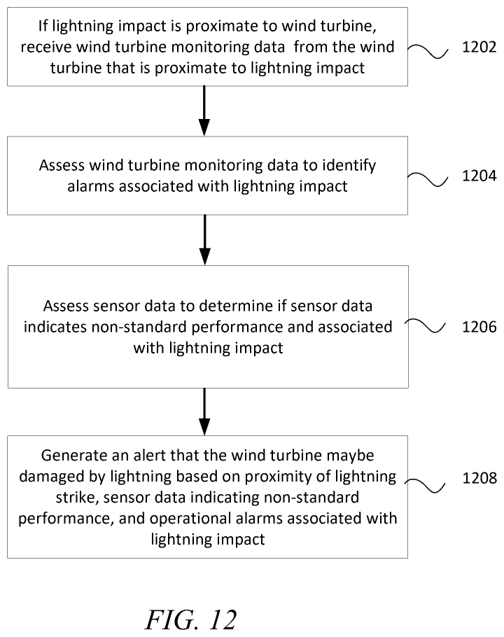

FIG. 12 is a flowchart of a process for generating an alarm (e.g., notification) of possible lightning related damage based on the determination of non-standard performance and operational alarms in some embodiments. The process in FIG. 12 may be similar to that of the process of FIG. 11, however operational alarms are also considered. Like FIG. 11, in this example, in step 1202, the communication module 302 receives lightning impact information from a lightning detection service. The lightning impact information includes location and time of a lightning strike. In some embodiments, the lightning impact information may include a magnitude and/or a polarity of the lightning strike.

The lightning range module 304 may, as discussed with regard to FIG. 4, determine if the lightning strike occurred within a predetermined range of a wind turbine. In step 1204, the optional alarm module 314 may assess wind turbine monitoring data for operating alarms generated by the wind turbine. As discussed herein, wind turbine monitoring data may include sensor data and operational alarms. In some embodiments, the wind turbine data only includes sensor data. In other embodiments, the wind turbine data may only include operational alarms.

The alarm module 314, may, in this example, only consider operational alarms that are generated at or near the time that the lightning strike occurred. Further, in some embodiments, the alarm module 314 may consider only particular alarms. For example, the alarm module 314 may review operational data for specific alarms generated immediately after the lightning strike (e.g., those alarms indicated in Table III). The alarm module 314 may continue to monitor sensor data for operational data that includes alarms of Table IV over time (e.g., over the next hour from the time when the lightning strike was reported to have occurred).

The alarm module 314 may, in some embodiments, disregard other operational alarms as not being related to lightning damage. In some embodiments, the alarm module 314 may disregard operational alarms that are not expected to be generated during the specific timeframes. For example, the alarm module 314 may disregard operational alarms that are not listed in Table III immediately after the lightning strike (e.g., within a particular, short time frame). The alarm module 314 may continue to receive and review operational data for operational alarms and consider operational alarms on Table IV during a second, particular longer time frame. If any of these alarms are present during the predetermined time frames after a lightning strike that occurs within a predetermined range, the alarm module 314 may notify the notification module 316.

In step 1206, the analysis module 312 may assess sensor data (e.g., sensor measurements) from the wind turbine monitoring data to determine if the sensor data is non-standard relative to healthy sensor measurements obtained in the past when the wind turbine (or a similar wind turbine) was healthy. In various embodiments, the analysis module 312 trains and utilizes a model as described with regard to FIG. 5. Non-standard sensor data (e.g., non-standard sensor measurements) includes data that is considered to be anomalous as discussed with regard to FIG. 5.

In step 1208, the notification module 316 generates and provides an alarm if anomalous data of the sensor data is detected and particular operating alarms are detected (e.g., the operating alarms detected in step 1204). In some embodiments, the notification module 316 is configured to generate a notification if anomalous data is detected or operating alarms are detected as discussed in steps 1204 and 1206. In various embodiments, the notification module 316 may generate a notification or alarm with information indicating if the alarm was triggered because of the detection of anomalous data detection, operating alarms, or both.

In various embodiments, a user may configure the lightning-impacted wind turbine detection system 102 to only send notifications if anomalous data is detected (e.g., as discussed with regard to step 1206), only send notifications if operating alerts are detected (e.g., as discussed with regard to step 1204), only send notifications if particular operating alerts are detected (e.g., one or more specific alerts identified in Tables III and/or IV), or only if both anomalous data and operating alerts are detected.

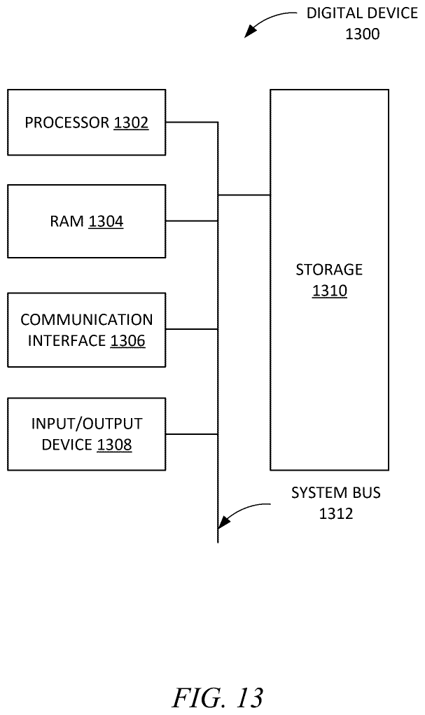

FIG. 13 depicts a block diagram of an example digital device 1300 according to some embodiments. The digital device 1300 is shown in the form of a general-purpose computing device. The digital device 1300 includes at least one processor 1302, RAM 1304, communication interface 1306, input/output device 1308, storage 1310, and a system bus 1312 that couples various system components including storage 1310 to the at least one processor 1302. A system, such as a computing system, may be or include one or more of the digital devices 1300.

System bus 1312 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1300 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1302 is configured to execute executable instructions (for example, programs). In some embodiments, the at least one processor 1302 comprises circuitry or any processor capable of processing the executable instructions.

In some embodiments, RAM 1304 stores programs or data. In various embodiments, working data is stored within RAM 1304. The data within RAM 1304 may be cleared or ultimately transferred to storage 1310, such as prior to reset or powering down the digital device 1300.

In some embodiments, the digital device 1300 is coupled to a network, such as the communication network 106, via communication interface 1306. The digital device 1300 can communicate with one or more networks such as a local area network (LAN), a general wide area network (WAN), or a public network (for example, the Internet).

In some embodiments, input/output device 1308 is any device that inputs data (for example, mouse, keyboard, stylus, sensors, etc.) or outputs data (for example, speaker, display, virtual reality headset).

In some embodiments, storage 1310 can include computer system readable media in the form of non-volatile memory, such as read only memory (ROM), programmable read only memory (PROM), solid-state drives (SSD), flash memory, or cache memory. Storage 1310 may further include other removable/non-removable, volatile/non-volatile computer system storage media. By way of example only, storage 1310 can be provided for reading from and writing to a non-removable, non-volatile magnetic media. The storage 1310 may include a non-transitory computer-readable medium, or multiple non-transitory computer-readable media, which stores programs or applications for performing functions such as those described herein with reference to, for example, FIG. 3. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1312 by one or more data media interfaces. As will be further depicted and described below, storage 1310 may include at least one program product having a set (for example, at least one) of program modules that are configured to carry out the functions of embodiments of the invention. In some embodiments, RAM 1304 is found within storage 1310.

Programs/utilities, having a set (at least one) of program modules, such as the property layout system, may be stored in storage 1310 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the invention as described herein.

It should be understood that although not shown, other hardware or software components could be used in conjunction with the digital device 1300. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations or block diagrams of methods, apparatus (systems) and computer program products according to embodiments of the invention. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “and/or” in this disclosure is not intended to be understood as an exclusive “or.” Rather, “or” is to be understood as including “or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. Therefore, variations of the example embodiments are intended to be covered by the disclosure herein.

1. A non-transitory computer-readable medium comprising executable instructions, the executable instructions being executable by one or more processors to perform a method, the method comprising:
receiving an indication of a location of a lightning strike;
determining that the location of the lightning strike is within a first range of at least one wind turbine;
receiving wind turbine monitoring data from the at least one wind turbine;
assessing the wind turbine monitoring data from the at least one wind turbine for non-standard performance;
determining if the wind turbine monitoring data indicating non-standard performance is correlated with a lightning impact; and
generating an alert that the at least one wind turbine may be damaged by lightning based on the lightning strike being within a first range of the at least one wind turbine and the determination that the wind turbine monitoring data indicates non-standard performance is correlated with the lightning impact.

2. The non-transitory computer-readable medium of claim 1, wherein the wind turbine monitoring data is supervisory control and data acquisition (SCADA) data.

3. The non-transitory computer-readable medium of claim 1, wherein determining if the wind turbine monitoring data indicating non-standard performance is correlated with the lightning impact comprises:
training a model to predict performance of a component of the at least one wind turbine during healthy conditions;
receiving SCADA data from the at least one wind turbine after the lightning strike occurred;
applying features from the SCADA data to the model to generate a predicted component performance; and
calculating a residual between predicted component performance and reported component performance after the lightning strike occurred.

4. The non-transitory computer-readable medium of claim 3, wherein the SCADA data includes wind speed, and pitch angle, and the predicted component performance is a predicted rotor speed, wherein applying the features from the SCADA data to the model comprising applying wind speed, pitch angle, and lagged rotor speed to the model.

5. The non-transitory computer-readable medium of claim 3, wherein the model is one of a plurality of models, each model of the plurality of models being for a different wind turbine.

6. The non-transitory computer-readable medium of claim 3, wherein the determination that the wind turbine monitoring data indicates non-standard performance is correlated with the lightning impact comprises comparing the residual to an anomaly threshold and generating the alert.

7. The non-transitory computer-readable medium of claim 3, wherein the alert indicates the residual is outside the anomaly threshold and an operational alarm from the at least one wind turbine is received after the lightning strike is detected.

8. The non-transitory computer-readable medium of claim 3, wherein the model includes an XGBoost based learning model.

9. The non-transitory computer-readable medium of claim 1, further comprising receiving an indication of an amplitude of the lightning strike.

10. The non-transitory computer-readable medium of claim 1, wherein the indication of the location of the lightning strike is received from a third-party lightning detection service.

11. The non-transitory computer-readable medium of claim 1, wherein an operator responsible for supervising the at least one wind turbine that receives the alert may change the first range to a greater or lesser range based on sensitivity to risk.

12. The non-transitory computer-readable medium of claim 1, wherein assessing the wind turbine monitoring data from the at least one wind turbine for non-standard performance occurs only if the lightning strike occurs within the first range.

13. The non-transitory computer-readable medium of claim 1, wherein determining if the wind turbine monitoring data indicating non-standard performance is correlated with the lightning impact comprises determining, at least in part, that the wind turbine monitoring data indicated performance different than the non-standard performance immediately before the lightning strike.

14. A system, comprising:
at least one processor; and
a non-transitory computer readable memory medium including executable instructions, the executable instructions being executable by the at least one processor to perform a method, the method comprising:
receiving an indication of a location of a lightning strike;
determining that the location of the lightning strike is within a first range of at least one wind turbine;
receiving wind turbine monitoring data from the at least one wind turbine;
assessing the wind turbine monitoring data from the at least one wind turbine for non-standard performance;
determining if the wind turbine monitoring data indicating non-standard performance is correlated with a lightning impact; and
generating an alert that the at least one wind turbine may be damaged by lightning based on the lightning strike being within a first range of the at least one wind turbine and the determination that the wind turbine monitoring data indicates non-standard performance is correlated with the lightning impact.

15. (canceled)

16. The system of claim 14, wherein the wind turbine monitoring data is supervisory control and data acquisition (SCADA) data.

17. The system of claim 14 wherein determining if the wind turbine monitoring data indicating non-standard performance is correlated with the lightning impact comprises:
training a model to predict performance of a component of the at least one wind turbine during healthy conditions;
receiving SCADA data from the at least one wind turbine after the lightning strike occurred;
applying features from the SCADA data to the model to generate a predicted component performance; and
calculating a residual between predicted component performance and reported component performance after the lightning strike occurred.

18. The system of claim 17, wherein the SCADA data includes wind speed, and pitch angle, and the predicted component performance is a predicted rotor speed, wherein applying the features from the SCADA data to the model comprising applying wind speed, pitch angle, and lagged rotor speed to the model.

19. The system of claim 17, wherein the model is one of a plurality of models, each model of the plurality of models being for a different wind turbine.

20. The system of claim 17, wherein the determination that the wind turbine monitoring data indicates non-standard performance is correlated with the lightning impact comprises comparing the residual to an anomaly threshold and generating the alert.

21. A method, comprising:
receiving an indication of a location of a lightning strike;
determining that the location of the lightning strike is within a first range of at least one wind turbine;
receiving wind turbine monitoring data from the at least one wind turbine;
assessing the wind turbine monitoring data from the at least one wind turbine for non-standard performance;
determining if the wind turbine monitoring data indicating non-standard performance is correlated with a lightning impact; and
generating an alert that the at least one wind turbine may be damaged by lightning based on the lightning strike being within a first range of the at least one wind turbine and the determination that the wind turbine monitoring data indicates non-standard performance is correlated with the lightning impact.
